(19) United States
(12) Patent Application Publication
(10) Pub. No.: US 2004/0077243 A1
(43) Pub. Date: Apr. 22, 2004

(54) Waterproof bedding

(76) Inventor: Bruce Strongwater, Englewood, NJ (US)

Correspondence Address: ABELMAN, FRAYNE & SCHWAB, 150 East 42nd Street, New York, NY, 10017-5612, US

(21) Appl. No.: 10/272,731

(22) Filed: Oct. 17, 2002

(51) Int. Cl. B32B 1/00; D03D 1/00; D03D 15/00; D03D 25/00; B32B 5/26; B32B 5/06; B32B 31/00

(52) U.S. Cl. 442/247; 442/181; 442/239; 442/240; 442/268; 442/270; 442/271; 156/148; 156/275.1

(57) ABSTRACT

A laminated waterproof bedding article is formed from a first layer of woven fabric, a second layer of woven or non-woven water-absorbent material that includes thermoplastic filaments, a third layer of a waterproof web of thermoplastic polymeric material, and an optional fourth layer of woven or non-woven fabric that includes thermoplastic filaments, the webs being joined along a plurality of spaced-apart seams to form a unitary structure; optional stitching, which can be decorative, intersects the heat-bonded seams.

### FIELD OF THE INVENTION

The invention relates to laminated waterproof bedding articles such as mattress and crib pads, pillow slips,-incontinent pads, sheeting and the like that is reusable after repeated washings.

### BACKGROUND OF THE INVENTION

A variety of waterproof bedding products have been developed that include a waterproof layer joined to one or more layers to form a reusable washable product. In some constructions, the waterproof or barrier layer is a poor conductor of heat, and the bedding is hot and uncomfortable to the user.

The construction of laminated bedding typically employs a large number of intersecting rows of stitching in order to produce a dimensionally stable finished article that can resist repeated washings. While this type of so-called quilt stitching can produce a pleasant decorative effect, it can have an adverse effect on the ability of the waterproof film or web, typically a polymeric material, to prevent passage of liquids to the underlying substrate. The use of numerous intersecting patterns or designs of stitching also adds to the cost of production of the bedding article.

It is desirable to render the bedding stable to repeated washings, particularly in institutional settings employing commercial laundering equipment, high temperature water and strong cleaning agents and disinfectants, where the bedding is subject to rapid wear and deterioration in both its aesthetic appearance and physical condition.

It is therefore an object of this invention to provide an,improved waterproof bedding article and a method for its manufacture that produces a laminated structure that is reusable and stable after repeated washings.

It is another object of the invention to provide such an article that is manufactured without passing stitching through the waterproof polymeric barrier layer and to otherwise avoid creating openings in the intermediate barrier layer.

It is a further object of the invention to provide a laminated waterproof bedding article and method for its manufacture that is economical and reliable.

### SUMMARY OF THE INVENTION

The above objects and other advantages are achieved by a laminated waterproof bedding construction that comprises: a first layer of woven or non-woven material that will readily pass liquids; a second layer of highly absorbent material that will absorb and diffuse liquid passing through the first layer; a third layer of waterproof polymeric material that will prevent the passage of liquid; and, optionally, a fourth layer of a woven or non-woven material that is resistant to tearing and deformation, where the four layers are bonded together along a plurality of spaced apart bonding lines to form a reusable, shape retaining, launderable article.

In a preferred embodiment, the upper layer that is in contact with the user, and referred to herein as the first layer, is a woven fabric. The first layer should not be water repellant; rather, it should readily transmit water or other liquids to the second layer. The first layer fabric can be a cotton or cotton/polyester blend, or any other fiber or blend of fibers that has the desired properties of comfort to the user. The first layer can be of a birdseye weave, satin stripes, or other decorative pattern of pleasing aesthetic effect. In applications such as protective mattress pads for use in hospitals, hotels and other institutional and commercial settings, a non-woven material can be used as the first layer. In these settings, the waterproof pad is typically covered with a bottom fitted sheet and is not seen or directly contacted by the user.

The second layer lies below the first layer and comprises the so-called “soaker material”. The second layer absorbs the liquid and disperses it from the initial area of contact. The thickness and adsorption properties of the second layer are selected based upon the expected use and volume of fluid that will be discharged. For example, when used as a crib pad or bottom sheet for an infant, less moisture adsorbing capacity will be required than when used as a mattress pad for an incontinent adult. The second layer is preferably a non-woven material. For example, the second layer can be a needle punched, air spun polyester blended with an absorbent fiber. In one preferred embodiment, a blend of 20% rayon or cotton and 80% polyester provides comfort and absorbency. Other absorbent and/or wicking materials that include natural and/or synthetic fibers can be utilized in this layer.

The material second layer can be from 1.5 oz/yd² up to about 10 oz/yd², the preferred weight being about 6 oz/yd².

The second layer contains a sufficient quantity of a thermoplastic material to form an effective bond with the adjacent layer or layers under the application of heat and pressure.

The third layer is formed from a polymer web or sheet. The polymer is preferably thermoplastic, that is, the web will melt when heated to form a tacky surface that can be caused to flow under pressure and provide an adhesive bond with the material of the other layers when the web is cooled.

The third layer is preferably a vinyl polymer or blend of vinyl and other polymers. Especially preferred is polyvinyl chloride having a thickness of from at least 4 to 6 mils/thousandths of an inch, or greater. A preferred thickness from the standpoint of performance characteristics, manufacturing control and economy is about 5 mils. Other materials of lesser thickness can also be used, depending upon the performance requirements or specifications and cost or pricing factors.

Other polymeric materials include polyurethane and polyethylene. Polyurethane is especially durable and can be utilized at a thickness as low as 2 mils, but at a cost that is somewhat greater than vinyl.

The optional fourth layer, which in the preferred embodiment is the bottom or opposing external layer, can be a non-woven fabric. The fourth layer can serve an aesthetic function to improve the hand or feel of the article, as well as its appearance. A non-woven material is preferred for reasons of economy in manufacture. However, for certain high end markets, a woven cotton blend containing polyester or other thermoplastic filaments can be employed.

Since the fourth layer will be in contact with the mattress or other supporting surface, the non-woven material must have a sufficient tensile strength and resistance to wear to meet the expected life of the product. Alternatively the fourth layer can be a woven fabric, that is the same type and grade as the first layer, or of a different weave or blend since it will not be in contact with the user or be required to pass liquid.

As will be apparent to one of ordinary skill in the art, one or more additional layers can be included in the laminated structure. For example, an expanded resilient polymeric foam layer can be added to provide additional padding and enhanced cushioning and softness. A bedding grade of polyurethane foam or other polymer foam can be used for this purpose.

A polyester fiber-fill material can also be used. A particular preferred form is a polyester filament that has been treated with a binder to retain its loft.

In a preferred embodiment the bonding lines are formed by the application of pressure to the laminate with heating to melt the third layer sufficiently to cause it to flow into contact with the first, second and optional fourth layers to form a secure bond.

In order to assure a secure construction of the laminated article, and its ability to withstand repeated washing, in an especially preferred embodiment, the first and second layers are stitched together along a plurality of spaced-apart stitching lines that intersect the bonding lines.

A polyester or other durable thread is used as the stitching for its dimensional stability in hot water washing. The stitching can be applied in parallel rows to intersect the heat-bonded rows, e.g., at a right angle to provide an efficient geometric pattern. Alternatively decorative patterns can be created with contrasting colored threads, using equipment and apparatus that is well known in the art. It will be understood that other quilting patterns and stitching and bonding methods known in the art can also be utilized.

In this embodiment, the first and second layers are most conveniently stitched together before being mated together with the third and, optionally, the fourth layers, and before the assembly is subjected to the heat-bonding. The layers can be stitched before the third and optional fourth layer are brought into position for the laminating operation utilizing methods and apparatus that are well known in the art. It will be understood that the stitching needle and thread do not penetrate the waterproof polymer web and the finished laminated article is completely waterproof.

### BRIEF DESCRIPTION OF THE DRAWINGS

The invention will be described in further detail below and with reference to the attached drawing sheets in which

FIG. 1 is a schematic exploded view of the four (4) sheets or webs forming the laminated structure of the invention;

FIG. 2 is a top plan view of one embodiment of the invention that has been bonded about it periphery and along two transverse lines and stitched along two intersecting lines;

FIG. 3 is another embodiment of the invention similar to FIG. 2 that has been edge-bonded and includes parallel, spaced bonding lines;

FIG. 4 is a cross-sectional view of the laminated structure of FIG. 2 taken along lines 4-4; and

FIG. 5 is another cross-sectional- view taken along lines 5-5 of FIG. 2.

### DETAILED DESCRIPTION OF THE INVENTION

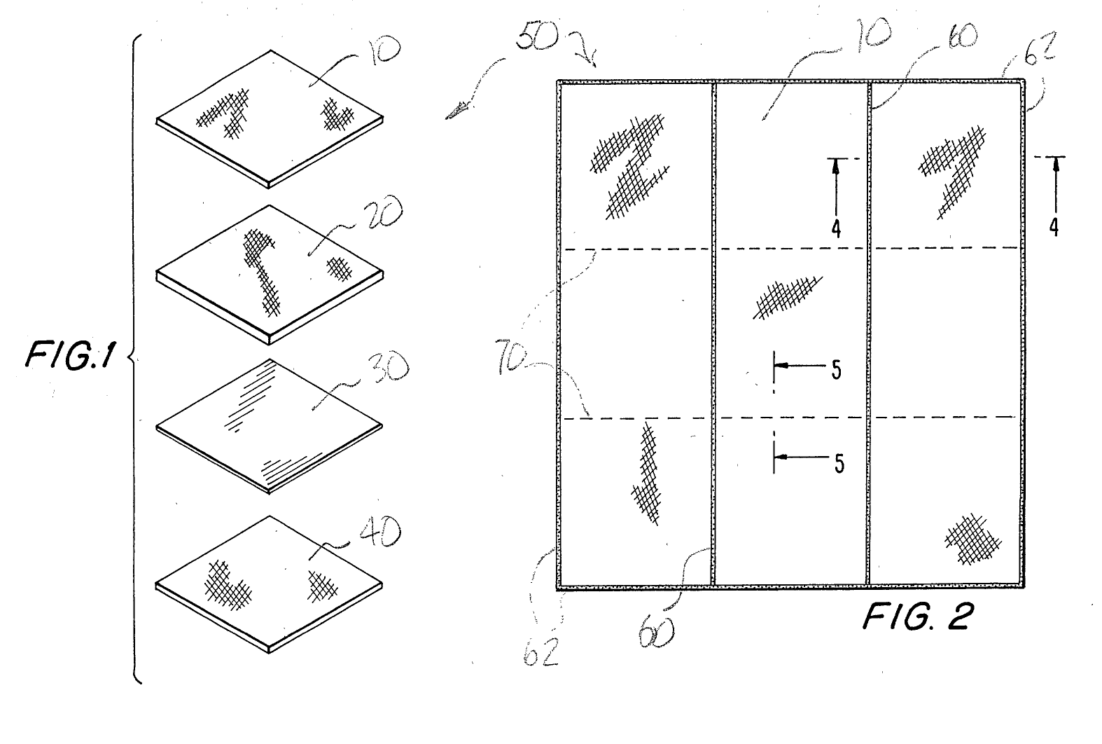

With reference to the attached drawings, there is shown in FIG. 1 a schematic illustration of the four sheets or webs that comprise the laminated structure 50. In a preferred method of manufacture of the laminate of the invention, four rolls are mounted on a conventional laminating machine to be fed in as a first layer of woven fabric (10), a second layer of woven or non-woven water-absorbent material (20) that includes thermoplastic filaments or fibers, a third layer of a waterproof web of thermoplastic polymeric material (30), and an optional fourth layer of woven or non-woven fabric (40) that includes thermoplastic filaments or fibers. The four superposed webs are moved through a conventional heat-bonding apparatus that provides the desired number of edge and intermediate lines of bonding of the polymeric material to the other three (3) layers. The heat can be supplied by heated wheels, platens or using ultrasonic, radio frequency or other high-energy means that are also well-known in the art. All four (4) edges are heat-bonded and the individual bedding articles are cut from the continuous web after the bonding is completed.

Alternatively, the edges can be cross stitched or finished with a fabric tape. The bonding preferably includes providing a heat-bonded seam extending transversely across the web on either side of the line of separation where the web will be cut into the predetermined desired lengths to provide individual bedding articles

If the fourth, or bottom layer (40) is included, it can be the same or a material that is different than first layer (10). The decision to utilize the fourth layer (40) below the waterproof web (30) can be based on the use and/or market in which the product is to be sold.

As further shown in FIG. 2, lines of stitching (70) are provided in spaced relation from each other and intersect heat-bonded lines (60) at right angles. As will be understood by one of ordinary skill in the art, any number of stitched seams can be introduced into the laminated article to serve both a utilitarian and/or decorative purpose. Such stitching is readily accomplished using existing automated equipment directed by an appropriately programmed computer. The effect of the heat-bonding and stitching is shown respectively, in FIGS. 4 and 5. The heat-bonding provides a relatively tight formation between the adjacent web members and can serve to reduce the transmission of liquid until it is absorbed within the heat-bonded boundaries of a given portion. The intersecting stitching (70) provides further integrity to the finished article that minimizes the likelihood that the outer or intermediate fabric and non-woven layers will be torn or lose their individual integrity.

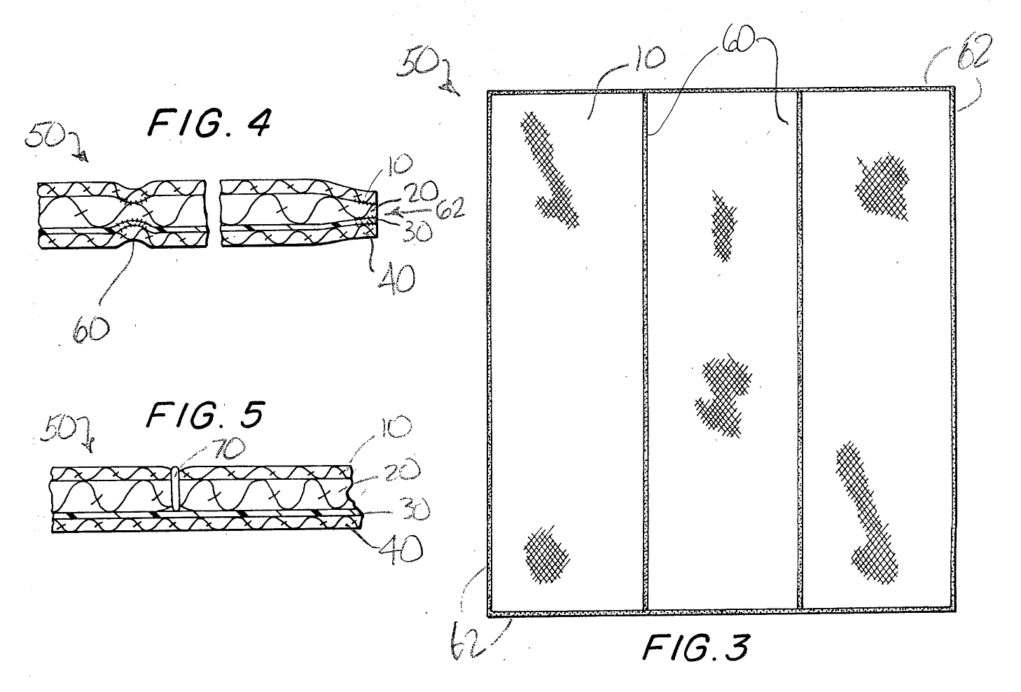

An alternative embodiment of the invention is illustrated in the plan view of FIG. 3, where the laminated article is edge-bonded along lines 62 and includes spaced apart parallel heat bonding lines (60).

In a preferred embodiment, the heat-bonding is accomplished using radio frequency energy in a process that is known in the trade as RF quilting. As will be understood by one of ordinary skill in the art, the construction illustrated in FIG. 3 is more economical to produce and possesses the same water-absorbent characteristics as the construction of FIG. 2. However, the absence of the lines of stitching means that the polymeric web or layer (30) remains un-perforated and therefore provides a complete barrier to liquids that may be entrained in the upper absorbent layers 10 and 20. This can be particularly important if the laminated article is to be used as a bedding pad for incontinent adult users who may discharge a significant volume of liquid that must be retained, and where subjected to a pressing action by the body's movement during some period of time before the individual can be removed from the bedding and the bedding stripped from the mattress.

As will be understood from the above disclosure, various modifications to the materials and methods of their assembly to form the laminated bedding article can be made within the spirit and scope of the present invention.

We claim:

1. A laminated waterproof bedding article comprising:
a first layer of woven fabric;
a second layer of woven or non-woven water-absorbent material that includes thermoplastic filaments;
a third layer of a waterproof web of thermoplastic polymeric material; and
an optional fourth layer of woven or non-woven fabric that includes thermoplastic filaments,
wherein the third layer is heat-bonded to the adjacent layer or layers along a plurality of spaced-apart seams to form a unitary structure.

2. The bedding article of claim 1, wherein the first and second layers are joined by stitching along a plurality of spaced-apart seams.

3. The bedding article of claim 2, wherein the stitched seams intersect the heat-bonded seams.

4. The bedding article of claim 1, wherein the polymeric material is selected from the group consisting of polyvinyl chloride and polyester.

5. The bedding article of claim 1, wherein the thermoplastic filaments are polyester.

6. The bedding article of claim 1, wherein the second layer is a lofted non-woven material having a weight of from about two to seven ounces per square yard.

7. The bedding article of claim 1 that further comprises an edge binding selected from the group consisting of overlock stitching and fabric tape.

8. The article of claim 1 that further comprises a skirt.

9. The article of claim 8, wherein the skirt is fitted.

10. The bedding article of claim 1, wherein the first layer is a fabric woven of cotton or a blend of cotton and polyester.

11. The bedding article of claim 3, wherein the stitched and bonded seams intersect at right angles.

12. The bedding article of claim 1 that includes a fourth layer that is a woven fabric having a polyester content of at least 35%.

13. The bedding article of claim 12, wherein the polyester fiber content of the fourth layer is at least 50%.

14. The bedding of claim 1, wherein the heat-bonded seams are formed by radio-frequency quilting.

15. A method of producing a laminated waterproof bedding article comprising the steps of:
a. feeding to a laminating machine a plurality of webs of substantially equal width, said webs including
a first layer of woven fabric,
a second layer of woven or non-woven water-absorbent material that includes thermoplastic filaments or fibers, and
a third layer of a waterproof thermoplastic polymeric material;
b. aligning the plurality of webs in a superposed position;
c. heat-bonding the superposed webs along a plurality of seam lines to thereby provide an integral waterproof laminate; and
d. separating a length of the laminated web along a line transverse to the longitudinal axis of the web to provide an article of bedding.

16. The method of claim 15, wherein the plurality of webs further includes a fourth layer of woven or non-woven fabric that includes thermoplastic filaments or fibers.

17. The method of claim 16, wherein the first and fourth outer layers are of the same fabric.

18. The method of claim 15 which includes the further step of stitching the first and second in a pattern that intersects the heat-bonded seams.

19. The method of claim 18, wherein the stitching produced an ornamental design.

20. The method of claim 15, wherein the heat-bonding of the seams is effected along a plurality of parallel, spaced-apart lines.
